(19) United States
(12) Patent Application Publication
(10) Pub. No.: US 2023/0061621 A1
(43) Pub. Date: Mar. 2, 2023

(54) TORQUE DETECTING STRUCTURE, TORQUE DETECTING ADAPTER AND TORQUE DETECTING SYSTEM

(71) Applicant: LIMOTEC METAL INDUSTRY LIMITED, TAICHUNG CITY (TW)

(72) Inventors: Tzu-Chien TSO, Taichung City (TW); Chih-Cheng CHENG, Taichung City (TW); Min Lang PAM, Taichung City (TW); Ren-Hao LIU, Taichung City (TW)

(21) Appl. No.: 17/821,478

(22) Filed: Aug. 23, 2022

(30) Foreign Application Priority Data
Aug. 25, 2021 (TW) 110131534

(51) Int. Cl. G01L 3/10; G01L 25/00

(52) U.S. Cl. CPC G01L 3/101; G01L 25/003

(57) ABSTRACT

A torque detecting structure includes at least one torque detecting unit installed at a main shaft and including an electric connecting portion, at least one first terminal detachably and electrically connected to the electric connecting portion of the at least one torque detecting unit, and a torque detecting control unit electrically connected to the at least one first terminal.

### RELATED APPLICATIONS

This application claims priority to Taiwan Application Serial No. 110131534, filed Aug. 25, 2021, which is herein incorporated by reference.

### BACKGROUND

### Technical Field

The present disclosure relates to a detecting structure, a detecting adapter and a detecting system. More particularly, the present disclosure relates to a torque detecting structure, a torque detecting adapter and a torque detecting system.

### Description of Related Art

In order to prevent breaking of the articles during fastening, torque detecting sensors are commonly installed on hand tools to show alarm or provide torque messages to the user as the predetermined torque is achieved. Conventional torque detecting structures can be separated into two types: torque detecting structures of mechanical type and torque detecting structures of digital type. The former uses springs to set the torque and provide jump function, but this kind of torque detecting structures are not accurate, and the torque value cannot be sent for management; therefore, torque detecting structures of digital type are used instead, which employ strain gauges to detect the torque. However, the prices of the torque detecting structures of digital type are high, and the cost thereof is increased.

Hence, digital torque detecting adapters are developed, which can provide torque detecting function as being connected with the hand tool, and the price thereof is relative cheap. Nevertheless, a conventional strain gauge is soldered to the circuit board via thin wires, once the strain gauge is abnormal or broken, the strain gauge has to be sent for repair or a new one has to be bought. As a result, the cost cannot be effectively reduced, and the problem needs to be improved.

### SUMMARY

According to one aspect of the present disclosure, a torque detecting structure includes at least one torque detecting unit installed at a main shaft and including an electric connecting portion, at least one first terminal detachably and electrically connected to the electric connecting portion of the at least one torque detecting unit, and a torque detecting control unit electrically connected to the at least one first terminal.

According to another aspect of the present disclosure, a torque detecting adapter which is applied to connect a driving tool includes a case, a main shaft penetrating the case and configured to connect the driving tool, and a torque detecting structure. The torque detecting structure includes at least one torque detecting unit installed at the main shaft and including an electric connecting portion, at least one first terminal detachably and electrically connected to the electric connecting portion of the at least one torque detecting unit, and a torque detecting control unit electrically connected to the at least one first terminal.

According to still another aspect of the present disclosure, a torque detecting system includes a plurality of torque detecting adapters and a charging storage box. The charging storage box includes a plurality of storage cavities and a plurality of charging modules. Each of the storage cavities is configured to accommodate each of the torque detecting adapters, and each of the charging modules is located at each of the storage cavities and configured to charge each of the torque detecting adapters.

According to yet still another aspect of the present disclosure, a torque detecting system consists of a plurality of torque detecting adapters, a charging storage box, and a receiver. The receiver is signally connected to each of the torque detecting adapters, and the receiver sends a message of each of the torque detecting adapters to an electronic device. The charging storage box includes a plurality of storage cavities and a plurality of charging modules. Each of the storage cavities is configured to accommodate each of the torque detecting adapters, and each of the charging modules is located at each of the storage cavities and configured to charge each of the torque detecting adapters.

### BRIEF DESCRIPTION OF THE DRAWINGS

The disclosure can be more fully understood by reading the following detailed description of the embodiments, with reference made to the accompanying drawings as follows:

FIG. 1 shows a three dimensional schematic view of a torque detecting adapter applied to a driving tool and a sleeve according to one embodiment of the present disclosure.

FIG. 2 shows an exploded view of the torque detecting adapter of FIG. 1.

FIG. 3 shows a cross section view of the torque detecting adapter of FIG. 1.

FIG. 4 shows a three dimensional schematic view of a torque detecting system according to another embodiment of the present disclosure.

FIG. 5 shows a block diagram of the torque detecting system of FIG. 4.

FIG. 6 shows a calibration diagram of the torque detecting system of FIG. 4.

### DETAILED DESCRIPTION

It will be understood that when an element (or mechanism or module) is referred to as being “disposed on”, “connected to” or “coupled to” another element, it can be directly disposed on, connected or coupled to the other element, or intervening elements may also be present. In contrast, when an element is referred to as being “directly disposed on”, “directly connected to” or “directly coupled to” another element, there are no intervening elements present.

In addition, the terms first, second, third, etc. are used herein to describe various elements or components, these elements or components should not be limited by these terms. Consequently, a first element or component discussed below could be termed a second element or component.

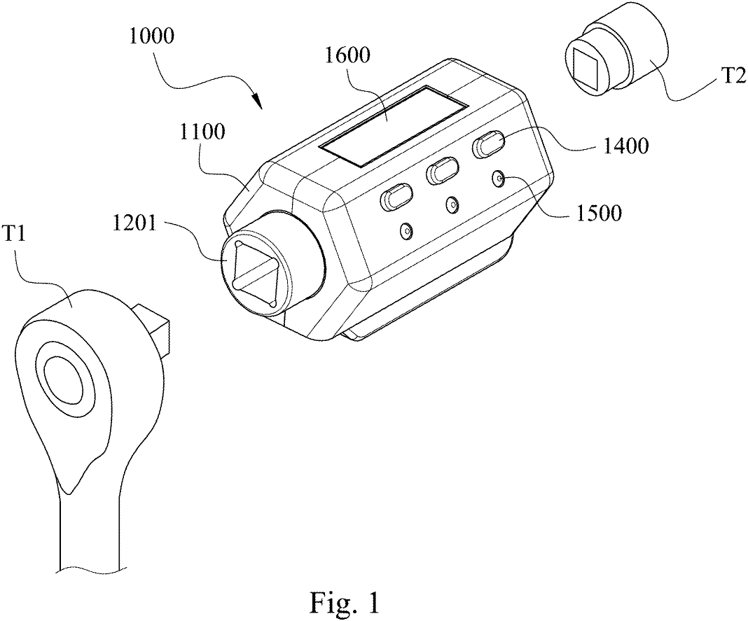

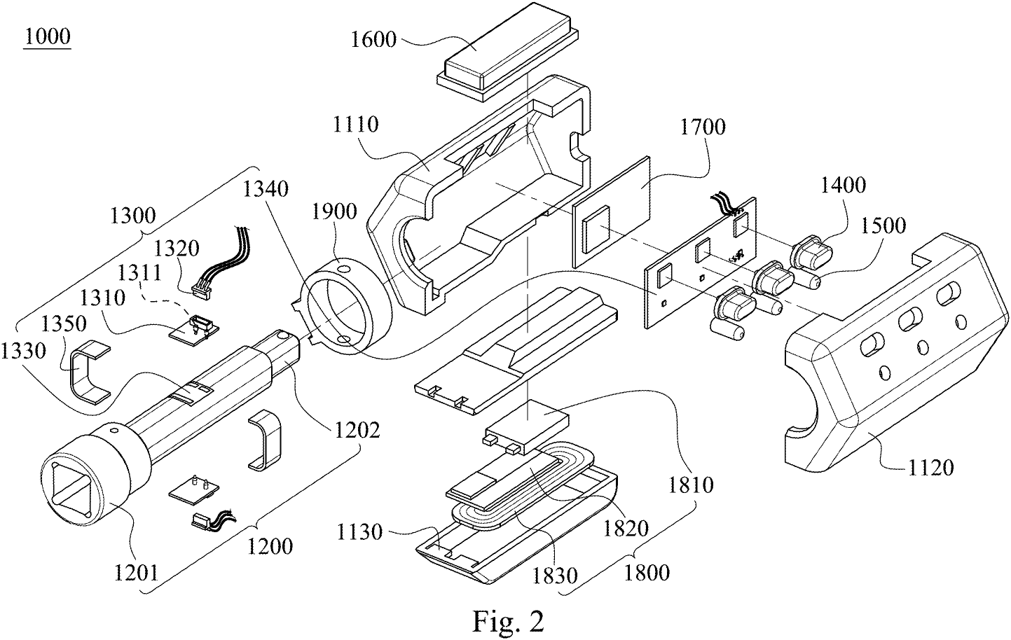

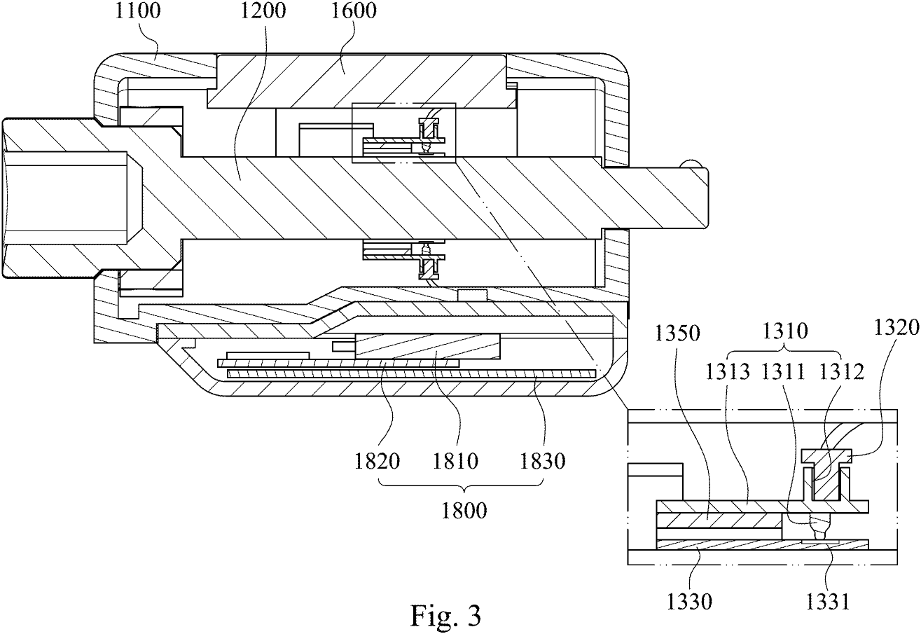

FIG. 1 shows a three dimensional schematic view of a torque detecting adapter 1000 applied to a driving tool T1 and a sleeve T2 according to one embodiment of the present disclosure. FIG. 2 shows an exploded view of the torque detecting adapter 1000 of FIG. 1. FIG. 3 shows a cross section view of the torque detecting adapter 1000 of FIG. 1. As shown in FIGS. 1 to 3, a torque detecting adapter 1000 which is applied to connect a driving tool T1 includes a case 1100, a main shaft 1200 penetrating the case 1100 and configured to connect the driving tool T1, and a torque detecting structure 1300. The torque detecting structure 1300 includes at least one torque detecting unit 1330 installed at the main shaft 1200 and including an electric connecting portion 1331, at least one first terminal 1310 detachably and electrically connected to the electric connecting portion 1331 of the at least one torque detecting unit 1330, and a torque detecting control unit 1340 electrically connected to the at least one first terminal 1310.

Therefore, through the detachable connection between the first terminal 1310 and the torque detecting unit 1330, the torque detecting unit 1330 can be replaced as being fail or broken, thereby achieving the advantages of easy repair and low cost. The details of the torque detecting adapter 1000 will be described hereinafter.

In the embodiment shown in FIGS. 1 to 3, the torque detecting structure 1300 can further include at least one second terminal 1320 electrically connected to the torque detecting control unit 1340 and detachably and electrically connected to the at least one first terminal 1310. A number of the torque detecting units 1330, a number of the first terminals 1310, and a number of the second terminals 1320 can all be two. Each first terminal 1310 can include two pins 1311, a hole 1312 and a terminal circuit board 1313. The hole 1312 is disposed at one side of the terminal circuit board 1313, and two pins 1311 are disposed at the other side of the terminal circuit board 1313. Each second terminal 1320 has a plug structure and can be detachably connected with each hole 1312. The torque detecting unit 1330 can have a strain gauge structure, the electric connecting portion 1331 can include two conductive metal sheets (not labeled), and the two pins 1311 of each first terminal 1310 may contact the two conductive metal sheets, respectively. A close circuit is formed as the pins 1311 contact the conductive metal sheets, and an open circuit is formed as the pins 1311 separate from the conductive metal sheets. Therefore, the torque detecting unit 1330 can be easily replaced, a number of the pins 1311 and a number of the conductive metal sheets can be modified based on real demands, and the present disclosure is not limited thereto. In addition, the torque detecting structure 1300 can further include a connecting bushing 1350 surrounding the main shaft 1200 and configured for the second terminal 1320 to be disposed thereon.

Please be noted that, although the torque detecting structure 1300 of FIGS. 1 to 3 is illustrated as being applied to the torque detecting adapter 1000 for detecting the torque of the main shaft 1200, in other embodiments, the torque detecting structure can be used in any driving tool which needs to measure the torque. For example, the torque detecting unit of the torque detecting structure can be directly disposed on the main shaft of a wrench such that no more extra torque detecting adapter is needed for the wrench. In addition, the torque detecting unit of the torque detecting structure can be directly disposed on the main shaft of a screw driver, and the present disclosure is not limited thereto.

The case 1100 can include a left housing 1110, a right housing 1120, and a battery cover 1130. The left housing 1110 and the right housing 1120 are assembled to form a main space. The main shaft 1200 penetrates the main space and is positioned by a positioning bushing 1900. A first end 1201 and a second end 1202 of the main shaft 1200 can expose from the case 1100. The first end 1201 can be used to connect the driving tool T1, the second end 1202 can be used to connect the sleeve T2, and the present disclosure is not limited thereto. The battery cover 1130 can be assembled with the left housing 1110 and the right housing 1120 to form a battery space for receiving a battery module 1800.

The battery module 1800 can be detachably and electric electrically connected to the torque detecting structure 1300 and can include a battery 1810 and a battery antenna 1830 electrically connected to the battery 1810. To be more specific, the battery module 1800 can further include a battery circuit board 1820, and the battery circuit board 1820 is located between the battery antenna 1830 and the battery 1810 and is electrically connected thereto. The battery antenna 1830 is adjacent to the battery cover 1130. As the battery antenna 1830 is close to a charging antenna (not shown in FIGS. 1 to 3), the battery antenna 1830 can generate an induced current and send the induced current to the battery circuit board 1820 for charging the battery 1810. Moreover, the battery cover 1130 can be removed or opened; consequently, the battery 1810 can be taken out independently for charging, and the present disclosure is not limited thereto.

The torque detecting adapter 1000 can further include a plurality of buttons 1400, a plurality of indicator 1500, a display 1600 and a first wireless communicating unit 1700. Each button 1400 is disposed at the case 1100 and corresponds to each pressing portion (not labeled) of the torque detecting control unit 1340, and each indicator 1500 is disposed at the case 1100 and can for example have a light guiding post structure so as to transmit the light of each of LED light sources (not labeled) of the torque detecting control unit 1340 to an outside of the case 1100 for indication. The display 1600 is disposed at the case 1100 and is signally connected to the torque detecting control unit 1340 for showing the torque value. The first wireless communicating unit 1700 is located in the main space and is signally connected to the torque detecting control unit 1340, thereby sending the torque value to a receiver (not shown in FIGS. 1 to 3).

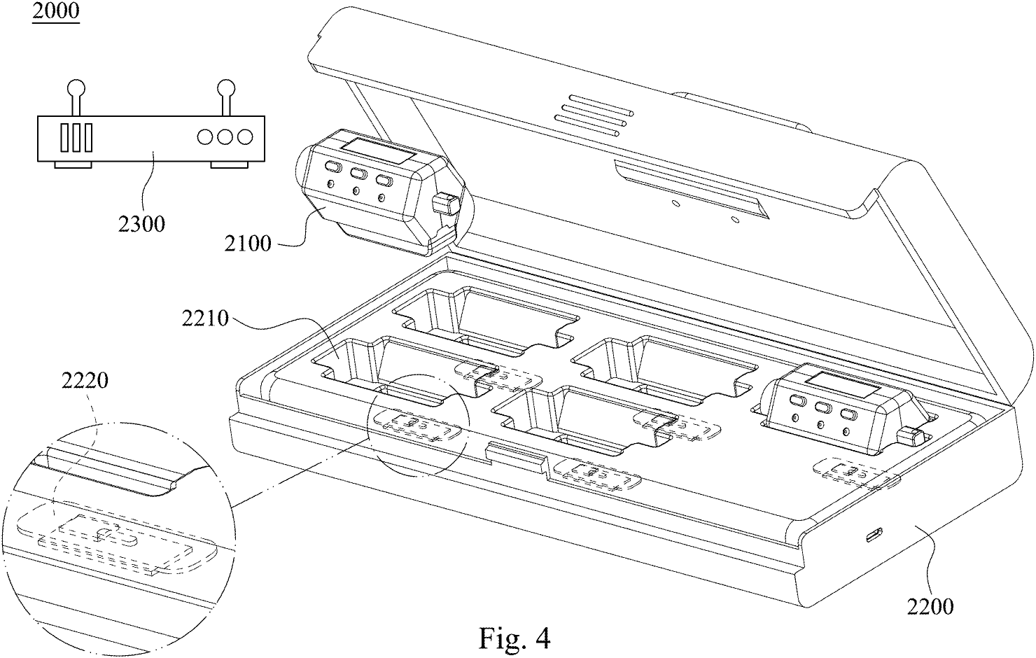

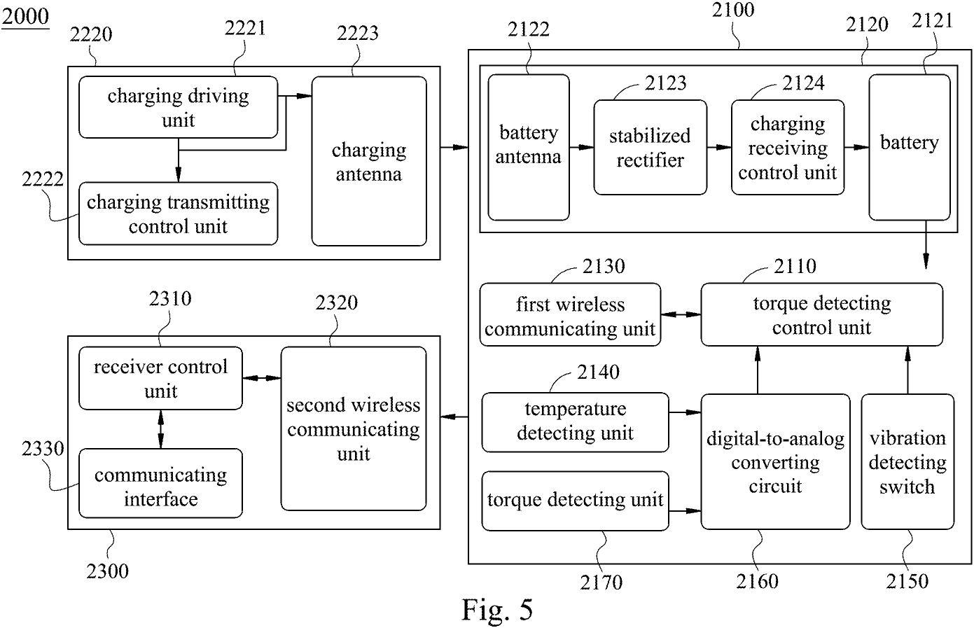

FIG. 4 shows a three dimensional schematic view of a torque detecting system 2000 according to another embodiment of the present disclosure. FIG. 5 shows a block diagram of the torque detecting system 2000 of FIG. 4. A torque detecting system 2000 includes a plurality of torque detecting adapters 2100 and a charging storage box 2200. The charging storage box 2200 includes a plurality of storage cavities 2210 each configured to accommodate each of the torque detecting adapters 2100, and a plurality of charging modules 2220 each located at each of the storage cavities 2210 and configured to charge each of the torque detecting adapters 2100. Hence, the charging storage box 2200 can have functions of storage and charging simultaneously, thereby increasing the convenience of usage and management. Please be noted that, although two torque detecting adapters 2100 are illustrated in FIG. 4, a number of the torque detecting adapters 2100 corresponds to a number of the storage cavities 2210.

In addition, in the embodiment shown in FIGS. 4 and 5, the torque detecting system 2000 can consist of the torque detecting adapters 2100, the charging storage box 2200, and a receiver 2300. The receiver 2300 is signally connected to each of the torque detecting adapters 2100, and the receiver 2300 sends a message of each of the torque detecting adapters 2100 to an electronic device (not shown). Therefore, only one receiver 2300 is used to receive the messages of lots of torque detecting adapters 2100, the receiver 2300 can send the massages to the electronic devices such as a cell phone, a computer, or a server, and the purpose of identifying the torque value and data storage can be down to achieve the goal of real-time monitoring and stable quality in industry 4.0. Moreover, the receiver 2300 can include a receiver control unit 2310, a second wireless communicating unit 2320 and a communicating interface 2330. The receiver control unit 2310 is electrically connected to the second wireless communicating unit 2320 and the communicating interface 2330. The second wireless communicating unit 2320 can send massages to the first wireless communicating unit 2130 of the torque detecting adapter 2100 via 2.4 G wireless connection. The receiver 2300 can then send the massages to the electronic device via the communicating interface 2330. The communicating interface 2330 can use at least one of the blue tooth communicating protocol and the UART communication protocol to communicate with the electronic device, and can be integrated with the original machine program.

The torque detecting adapter 2100 is similar to the torque detecting adapter 1000 of FIGS. 1 to 3 and includes a torque detecting control unit 2110, a torque detecting unit 2170 and a first wireless communicating unit 2130. In addition, the torque detecting adapter 2100 can further include a vibration detecting switch 2150, a temperature detecting unit 2140 and a digital-to-analog converting circuit 2160. The vibration detecting switch 2150 is signally connected to the torque detecting control unit 2110 and configured to detect a vibration. As the vibration detecting switch 2150 detects the vibration, the torque detecting adapter 2100 is turned on. As the vibration detecting switch 2150 does not detect any vibration during a period, the torque detecting adapter 2100 sleeps or is turn off to save the power. The temperature detecting unit 2140 is signally connected to the torque detecting control unit 2110 and configured to detect a temperature, and the temperature can be used to calibrate the torque value to increase the accuracy of torque measurement. The digital-to-analog converting circuit 2160 is electrically connected between the torque detecting control unit 2110, the temperature detecting unit 2140 and the torque detecting unit 2170 so as to convert the analog signals to digital signals to the torque detecting control unit 2110.

The battery module 2120 of the torque detecting adapter 2100 is identical to the battery module 1800 of FIGS. 1 to 3 and includes a battery 2121, a battery antenna 2122 and a battery circuit board (not labeled). The battery circuit board can include a stabilized rectifier 2123 and a charging receiving control unit 2124. The stabilized rectifier 2123 can be used for stabilize the voltage and the current, and the charging receiving control unit 2124 can be used to control the charge.

The charging module 2220 of the charging storage box 2200 can be located at a bottom of each storage cavities 2210 and include a charging antenna 2223, a charging driving unit 2221 and a charging transmitting control unit 2222. The charging antenna 2223, the charging driving unit 2221 and the charging transmitting control unit 2222 are electrically connected. The charging storage box 2200 can further include a charging port such as a USB port to be electrically connected to a charging hole, thereby allowing each charging module 2220 to charge the battery module 2120. Hence, the battery antenna 2122 of one of the torque detecting adapters 2100 can be wireless charged as being corresponding to one charging antenna 2223. Furthermore, the aforementioned one of the torque detecting adapters 2100 can execute torque calibration.

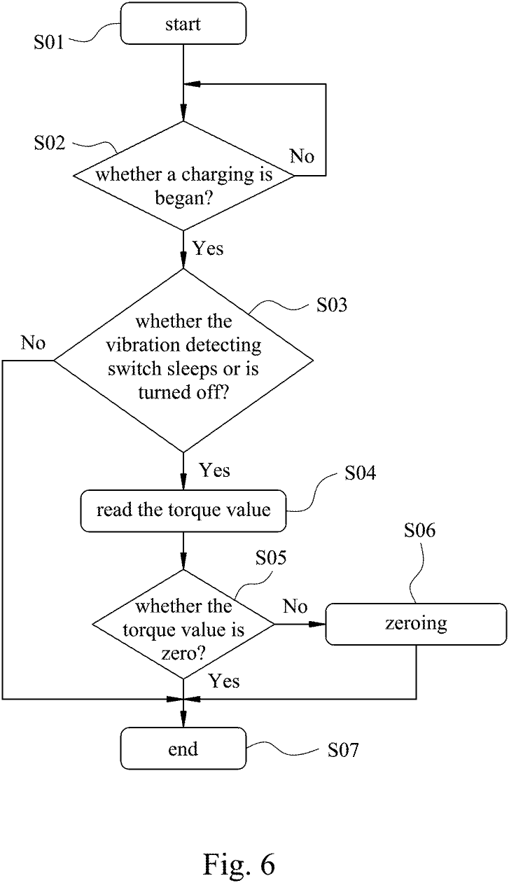

FIG. 6 shows a calibration diagram of the torque detecting system 2000 of FIG. 4. Please refer to FIG. 6 with references of FIGS. 4 and 5, a calibrating program can be previously download in the torque detecting control unit 2110 of the torque detecting adapter 2100, and in Step S01, the calibrating program starts. Step S02 is entered to confirm whether a charging is began. If yes, Step S03 is entered to confirm whether the vibration detecting switch 2150 sleeps or is turned off for confirming that the torque detecting adapter 2100 is not being used. If the vibration detecting switch 2150 does not sleep or be turned off, Step S07 is entered to close the calibrating program. On the contrary, if the vibration detecting switch 2150 sleeps or is turned off, Step S04 is entered to read the torque value and Step S05 is entered to confirm whether the torque vale is zero. In a normal situation, the torque value should be zero if the torque detecting adapter 2100 is not being used; if the torque value is not zero, zeroing of Step S06 is executed for ensuring the accuracy in next operation. If the torque value is zero, no calibration is needed, and Step S07 is entered to close the calibrating program.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A torque detecting structure, comprising:
at least one torque detecting unit installed at a main shaft and comprising an electric connecting portion;
at least one first terminal detachably and electrically connected to the electric connecting portion of the at least one torque detecting unit; and
a torque detecting control unit electrically connected to the at least one first terminal.

2. The torque detecting structure of claim 1, wherein the electric connecting portion of the at least one torque detecting unit comprises at least two conductive metal sheets, and the at least one first terminal comprises at least two pins to contact the at least two conductive metal sheets of the at least one torque detecting unit, respectively.

3. The torque detecting structure of claim 1, further comprising:
at least one second terminal electrically connected to the torque detecting control unit and detachably and electrically connected to the at least one first terminal.

4. A torque detecting adapter, which is applied to connect a driving tool, the torque detecting adapter comprising:
a case;
a main shaft penetrating the case and configured to connect the driving tool; and
a torque detecting structure, comprising:
at least one torque detecting unit installed at the main shaft and comprising an electric connecting portion;
at least one first terminal detachably and electrically connected to the electric connecting portion of the at least one torque detecting unit; and
a torque detecting control unit electrically connected to the at least one first terminal.

5. The torque detecting adapter of claim 4, further comprising at least one second terminal electrically connected to the torque detecting control unit and detachably and electrically connected to the at least one first terminal, the electric connecting portion of the at least one torque detecting unit comprising at least two conductive metal sheets, and the at least one first terminal comprising at least two pins to contact the at least two conductive metal sheets of the at least one torque detecting unit, respectively.

6. The torque detecting adapter of claim 4, further comprising a battery module detachably and electrically connected to the torque detecting structure and comprising:
a battery; and
a battery antenna electrically connected to the battery.

7. The torque detecting adapter of claim 4, further comprising:
a temperature detecting unit signally connected to the torque detecting control unit and configured to detect a temperature; and
a vibration detecting switch signally connected to the torque detecting control unit and configured to detect a vibration;
wherein as the vibration detecting switch detects the vibration, the torque detecting adapter is turned on.

8. A torque detecting system, comprising:
a plurality of torque detecting adapters of claim 4; and
a charging storage box, comprising:
a plurality of storage cavities, each of the storage cavities configured to accommodate each of the torque detecting adapters; and
a plurality of charging modules, each of the charging modules located at each of the storage cavities and configured to charge each of the torque detecting adapters.

9. The torque detecting system of claim 8, wherein each of the torque detecting adapters further comprises a battery module, each of the battery modules comprises a battery and a battery antenna, each of the battery antennas is electrically connected to the battery, each of the charging modules comprises a charging antenna, a wireless charge is conducted as the battery of one of the torque detecting adapters corresponds to one of the charging antennas, and a torque calibration is conducted by the torque detecting control unit of the one of the torque detecting adapters.

10. A torque detecting system consisting of a plurality of torque detecting adapters of claim 4, a charging storage box, and a receiver, wherein the receiver is signally connected to each of the torque detecting adapters, the receiver sends a message of each of the torque detecting adapters to an electronic device, and the charging storage box comprises:
a plurality of storage cavities, each of the storage cavities configured to accommodate each of the torque detecting adapters; and
a plurality of charging modules, each of the charging modules located at each of the storage cavities and configured to charge each of the torque detecting adapters.
